(19) United States
(12) Patent Application Publication
(10) Pub. No.: US 2024/0163572 A1
(43) Pub. Date: May 16, 2024

(54) IMAGE PROCESSING DEVICE, NON-TRANSITORY COMPUTER-READABLE MEDIUM, AND IMAGE PROCESSING METHOD

(71) Applicant: Morpho, Inc., Tokyo (JP)

(72) Inventors: Soma YAMAGUCHI, Tokyo (JP); Michihiro KOBAYASHI, Tokyo (JP)

(73) Assignee: Morpho, Inc., Tokyo (JP)

(21) Appl. No.: 18/283,450

(22) PCT Filed: Feb. 2, 2022
(86) PCT No.: PCT/JP2022/004077

§ 371 Date: Sep. 22, 2023

(30) Foreign Application Priority Data
Mar. 30, 2021 (JP) 2021-057715

(51) Int. Cl. H04N 23/81; H04N 23/84

(52) U.S. Cl. CPC H04N 23/81; H04N 23/843

(57) ABSTRACT

An image processing device includes: a first processing unit that detects corresponding pixels between reference image data selected from a plurality of pieces of raw image data and each of a plurality of pieces of comparison image data included in the raw image data, and synthesizes the reference image data and the comparison image data on the basis of the corresponding pixels to generate synthesized raw image data; a map generation unit that generates map information associating a pixel position of the synthesized raw image data with information derived from at least one piece of the raw image data; and a second processing unit that executes image processing different from that of the first processing unit on the demosaiced synthesized raw image data on the basis of the map information generated by the map generation unit.

### TECHNICAL FIELD

The present disclosure relates to an image processing device, an image processing program, and an image processing method.

### RELATED ART

Patent Document 1 discloses a device that reduces noise. In this device, among N+1 pieces of raw image data generated by an image sensor, one piece of raw image data serving as a reference is aligned with N pieces of raw image data, and a pixel value is blended for each pixel, thereby generating an image with reduced noise. A low blending ratio is set for a moving subject area of the raw image data, and priority is given to information of the raw image data serving as the reference. A low-pass filter is applied to synthesized image data obtained by blending, and the pixel value of a pixel position corresponding to the moving subject area is smoothed.

A technique for reducing noise using a plurality of pieces of image data is called multi-frame noise reduction (MFNR), and a technique for generating an image with reduced noise from only one image is called single-frame noise reduction (SFNR). The device described in Patent Document 1 applies MFNR to a still subject area and applies SFNR to a moving subject area. Accordingly, noise in the entire image is reduced with high accuracy.

The N+1 pieces of raw image data are subjected to color interpolation processing (demosaicing) for conversion into full-color image data, white balance, a linear matrix for improving color reproducibility, edge enhancement processing for improving visibility, or the like, encoded by a compression codec such as JPEG, and stored in a recording/playback unit. Then, the N+1 pieces of full-color image data stored in the recording/playback unit are subjected to the same processing as the above-described method for generating one piece of synthesized image data from the N+1 pieces of raw image data, and one piece of synthesized image data is generated. The device described in Patent Document 1 enables common use of circuits by performing the same processing on the raw image data as on the full-color image data.

### PRIOR-ART DOCUMENTS

### Patent Documents

Patent Document 1: Japanese Patent Laid-open No. 2012-186593

### SUMMARY OF THE INVENTION

### Problems to Be Solved by the Invention

The raw image data before demosaicing is information close to sensor data itself rather than being in a visible state as an image, in which information in accordance with natural law is maintained. Hence, processing for predicting a numerical value using natural law may be suitably carried out. On the other hand, even if effective image processing can be performed on the raw image data, since demosaicing or other processing is executed in a subsequent stage, there is a possibility that the effect of the image processing may be reduced.

Since the full-color image data (RGB image data or YUV image data) after demosaicing is in a visible state as an image, it is suitable for processing that directly affects an image to be output as a final result, such as processing for elaborating or making final adjustment to visibility. However, since the image processing applied to the full-color image data is image processing that intentionally modifies a pixel value, such as filter processing or correction processing, the information in accordance with natural law may not be maintained. Hence, there is a possibility that accurate information may not be obtained even if the processing for predicting a numerical value using natural law is executed on the full-color image data.

In the device described in Patent Document 1, the same processing is executed on the image data before demosaicing as on the image data after demosaicing, and processing considering advantages of image processing performed on raw image data and advantages of image processing performed on full-color image data cannot be performed. The present disclosure provides a technique in which advantages of image processing performed on raw image data can be combined with advantages of image processing performed on full-color image data, and image quality can be improved.

### Means for Solving the Problems

An image processing device according to one aspect of the present disclosure includes a first processing unit, a map generation unit, and a second processing unit. The first processing unit detects corresponding pixels between reference image data selected from among a plurality of pieces of raw image data and each of a plurality of pieces of comparison image data included in the plurality of pieces of raw image data. The first processing unit synthesizes the reference image data and the plurality of pieces of comparison image data on the basis of the corresponding pixels, and generates synthesized raw image data. The map generation unit generates map information in which a pixel position of the synthesized raw image data is associated with information derived from at least one piece of raw image data of the plurality of pieces of raw image data. The second processing unit executes image processing different from that of the first processing unit on the synthesized raw image data that has been demosaiced.

### Effects of the Invention

According to the present disclosure, advantages of image processing performed on raw image data can be combined with advantages of image processing performed on full-color image data, and image quality can be improved.

### BRIEF DESCRIPTION OF THE DRAWINGS

FIG. 1 is a block diagram showing a hardware configuration of an image processing device according to an embodiment.

FIG. 2 is a block diagram describing image processing executed by an image processing device.

FIG. 3 is a block diagram describing processing for bypassing a part of preprocessing.

FIG. 4 is a schematic diagram describing first extension processing.

FIG. 5 is a flowchart of an image processing method.

### DESCRIPTION OF THE EMBODIMENTS

An embodiment of the present disclosure is hereinafter described with reference to the drawings. In the following description, the same or corresponding elements are denoted by the same reference numerals, and repeated descriptions are omitted. (Configuration of Image Processing Device)

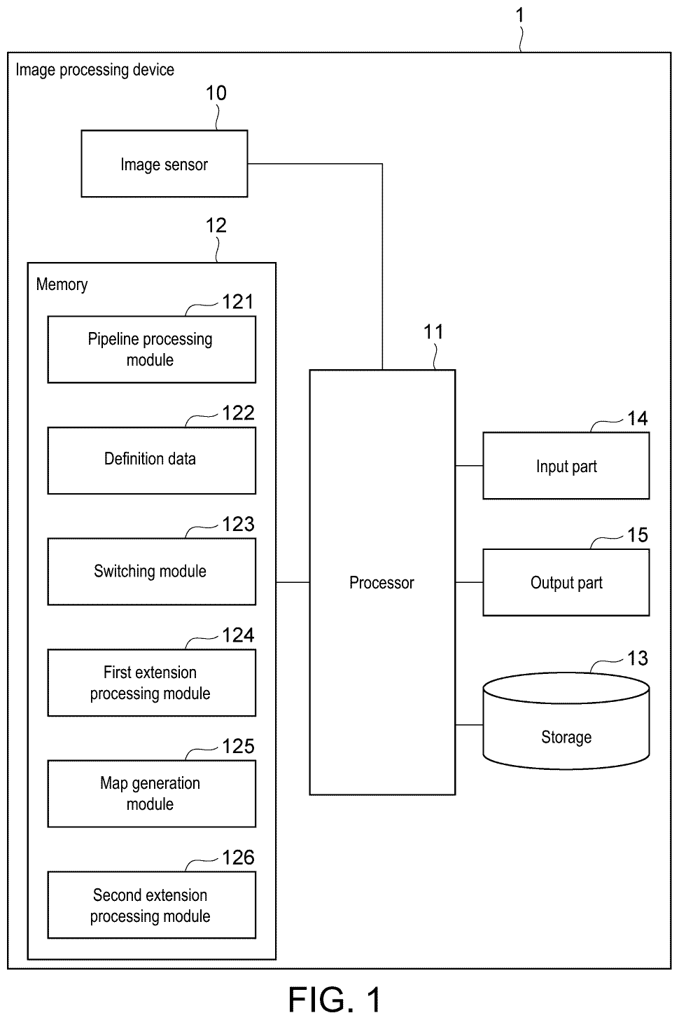

FIG. 1 is a block diagram showing a hardware configuration of an image processing device according to an embodiment. An image processing device 1 shown in FIG. 1 is a device having an imaging function, such as a smartphone. The image processing device 1 sequentially applies an image processing group consisting of a series of image processings to image data. In the following, a flow of the image processing group consisting of a series of image processings is also referred to as an image processing pipeline.

As shown in FIG. 1, the image processing device 1 includes an image sensor 10, a processor 11, a memory 12 (an example of a storage unit), a storage 13, an input part 14, and an output part 15. The processor 11 is communicably connected to the image sensor 10, the memory 12, the storage 13, the input part 14, and the output part 15.

The image sensor 10 is a solid-state imaging device and outputs raw image data. The raw image data is color image data recorded a mosaic array. An example of the mosaic array is a Bayer array. The image sensor 10 may have a continuous shooting function. In this case, the image sensor 10 generates a plurality of pieces of raw image data that are continuous. The processor 11 is a computing device that executes the image processing pipeline, and examples thereof include an image signal processor (ISP) optimized for image signal processing. The processor 11 may not only include an ISP, and may include a graphics processing unit (GPU) or a central processing unit (CPU). According to the type of each image processing in the image processing pipeline, the ISP may be combined with a GPU or CPU to execute each image processing. The processor 11 executes the image processing pipeline with respect to each piece of raw image data output from the image sensor 10.

The memory 12 and the storage 13 are storage media. In the example shown in FIG. 1, the memory 12 stores a program module to be executed by the processor 11, definition data, raw image data, intermediate image data and map information described later, or the like. The memory 12 includes, for example, a synchronous dynamic random access memory (SDRAM). The storage 13 stores image data processed by the image processing pipeline, or the like. The image data processed by the image processing pipeline includes, for example, RGB image data or YUV image data. The storage 13 includes, for example, a hard disk drive (HDD). The memory 12 and the storage 13 are not particularly limited if they are storage media. The memory 12 and the storage 13 may be composed of a single piece of hardware.

The memory 12 includes a pipeline processing module 121 for executing the image processing pipeline. The processor 11 executes the image processing pipeline with reference to the memory 12. The memory 12 stores definition data 122 and a switching module 123 for switching the image processing pipeline, which will be described later. Furthermore, the memory 12 stores a first extension processing module 124 (an example of a first processing unit) and a map generation module 125 (an example of a map generation unit) that are executed during switching of the image processing pipeline described later, as well as a second extension processing module 126 (an example of a second processing unit) that is executed after execution of the image processing pipeline.

The input part 14 is a user interface that receives a user operation, and examples thereof include an operation button. The output part 15 is a device displaying image data, and examples thereof include a display device. The input part 14 and the output part 15 may be composed of a single piece of hardware such as a touch screen.

### Overview of Image Processing Pipeline

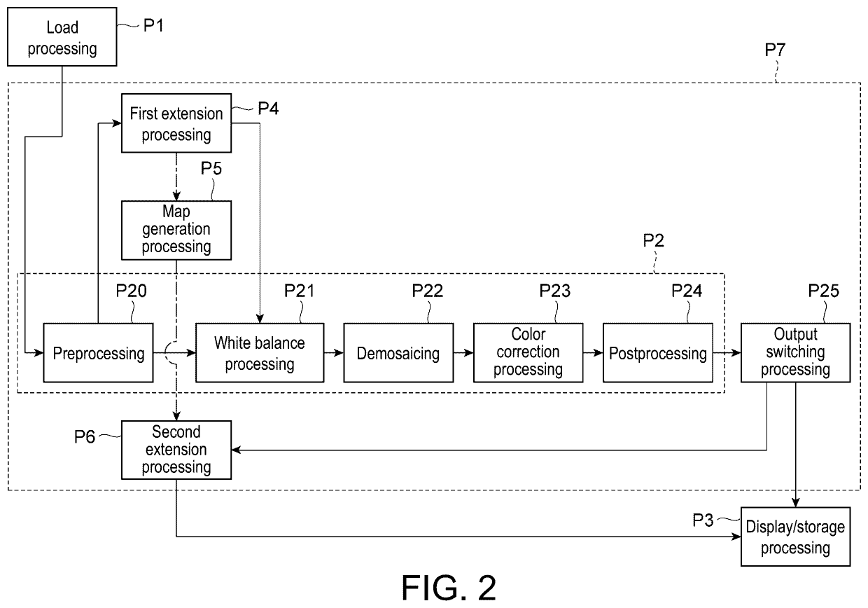

FIG. 2 is a block diagram describing image processing executed by an image processing device. The processor 11 executes an image processing pipeline P2 on the basis of the pipeline processing module 121. First, the processor 11 loads the raw image data stored in the memory 12 (load processing P1). Then, the processor 11 sequentially executes a plurality of image processings on the raw image data (image processing pipeline P2). Then, the processor 11 obtains YUV image data as a processing result of the image processing pipeline P2. The pipeline processing module 121 is a program that causes the processor 11 to function to execute the operations described above. The processor 11 is able to cause the output part 15 to output the processing result, or cause the storage 13 to store the processing result (display/storage processing P3). In the example shown in FIG. 2, the processor 11 may also be able to execute image processing prior to the display/storage processing P3, and details thereof will be described later.

The pipeline processing module 121 causes the processor 11 to execute, as the image processing pipeline P2, preprocessing P20, white balance processing P21, demosaicing P22, color correction processing P23, and postprocessing P24 in this order.

In the preprocessing P20, image processing is executed targeted on image data in Bayer format, which is raw image data. Details of the preprocessing P20 will be described later. Next, in the white balance processing P21, with respect to the image data on which the preprocessing P20 has been executed, the intensity of each RGB color component is corrected. Next, in the demosaicing P22, with respect to the image data on which the white balance processing P21 has been executed, a pixel lacking in color information in Bayer format is interpolated, and RGB image data is generated. Next, in the color correction processing P23, the RGB image data is color corrected. Finally, in the postprocessing P24, color space conversion from RGB format to YUV format and image processing targeted on the YUV format are performed. The image processing pipeline P2 shown in FIG. 2 is an example and may take various forms. The image processing pipeline P2 is not limited to the example shown in FIG. 2. It is possible to change the order of the image processings shown in FIG. 2, or to delete image processing or add new image processing.

### Extension of Image Processing Pipeline

The image processing device 1 extends the image processing pipeline P2 described above. Specifically, in a stage preceding the demosaicing P22, the image processing device 1 executes image processing in place of part of the image processing of the image processing pipeline P2 (first extension processing P4). Furthermore, the image processing device 1 performs image processing on the image data processed by the image processing pipeline P2 (second extension processing P6). The image processing device 1 causes the output part 15 to output a processing result of the second extension processing P6, or causes the storage 13 to store the processing result of the second extension processing P6.

The image processing device 1 may be configured to selectively execute or always execute an extension function of an image processing pipeline. In the following, an example is disclosed in which the extension function of the image processing pipeline is selectively executed. However, the image processing device 1 may not have to include the configuration for selectively executing the extension function.

The image processing device 1 has a function of selecting bypassing of processing as necessary with respect to each image processing in the image processing pipeline P2. The image processing device 1, after bypassing target image processing, executes the first extension processing P4 instead of the target image processing. The target image processing is image processing to be bypassed among the image processings included in the image processing pipeline P2. The first extension processing P4 is processing different from each image processing in the image processing pipeline P2. Accordingly, a new image processing option is given to the image processing pipeline P2. The image processing pipeline P2 and the first extension processing P4 are executed by the processor 11.

Specifically, which image processing is to be bypassed is determined depending on the content of the incorporated first extension processing P4. A user creates the definition data 122 so that one or a plurality of image processings included in the image processing pipeline P2 are bypassed according to the content of the first extension processing P4. The definition data 122 is stored in the memory 12. The definition data 122 includes a definition indicating which image processing is the target image processing and a definition indicating that the image processing to be executed after bypassing is the first extension processing P4. By the user performing setting to bypass image processing in which performance of the first extension processing P4 is degraded, the image data in which a function of the first extension processing P4 is sufficiently exhibited can be passed to subsequent processing.

In the following, a case where the first extension processing P4 is noise reduction processing on the basis of a plurality of pieces of image data is described as an example. The noise reduction processing on the basis of a plurality of pieces of image data is called MFNR, in which noise contained in image data obtained by continuous shooting is reduced by calculating an average value of pixels of the image data.

In execution of MFNR, a moving object is detected on the basis of a difference in pixel value between images in order to prevent multiple blurring due to synthesis. In order to properly detect the moving object, it must be determined whether the difference in pixel value between images is caused by a movement of the object or by noise contained in an image. For this purpose, proper estimation of an intensity of the noise contained in the image is important. In general, a noise intensity can be estimated with high accuracy from ISO sensitivity at the time of shooting by using calibration data at the time of factory shipment or the like. A reason is that these intensities vary in accordance with natural law.

The image processing pipeline P2 may include processing for varying a noise intensity of the image. Examples of such processing include SFNR or peripheral light falloff correction processing. In SFNR, noise in one image is reduced using a low frequency filter or the like. In the peripheral light falloff correction processing, in order to avoid a phenomenon that the quantity of light around an image is reduced due to characteristics of a lens, luminance of a peripheral region of the image is amplified. Since the noise intensity estimation method using natural law described above is not based on image data that has undergone the processing for varying the noise intensity, when such image data is taken as a target, there is a possibility that sufficient estimation accuracy cannot be achieved.

Hence, if the first extension processing P4 is executed, the definition data 122 is generated so as to bypass the processing for varying the noise intensity of the image. Accordingly, in the first extension processing P4, image data imparted with noise characteristics serving as the basis is input, and relatively proper image processing is realized.

The processor 11 bypasses the target image processing of the image processing pipeline P2 on the basis of the switching module 123. For example, the processor 11 determines whether a predetermined switching condition has been satisfied. The predetermined switching condition is a condition for determining whether bypassing is necessary, and is determined in advance. The predetermined switching condition may be, for example, reception of a user operation that enables the first extension processing P4, or satisfaction of a predetermined condition for time or environment. In the case where the predetermined switching condition is satisfied, the processor 11 bypasses the target image processing of the image processing pipeline P2 in accordance with the definition data 122. The switching module 123 is a program that causes the processor 11 to function to execute a series of operations that bypass the target image processing described above. In the example shown in FIG. 2, the preprocessing P20 is switched to the first extension processing P4 in the middle of execution, and the first extension processing P4 is executed. A processing result of the first extension processing P4 is returned to the image processing pipeline P2, and the white balance processing P21, the demosaicing P22, the color correction processing P23, and the postprocessing P24 are executed in order.

### Details of Switching Processing

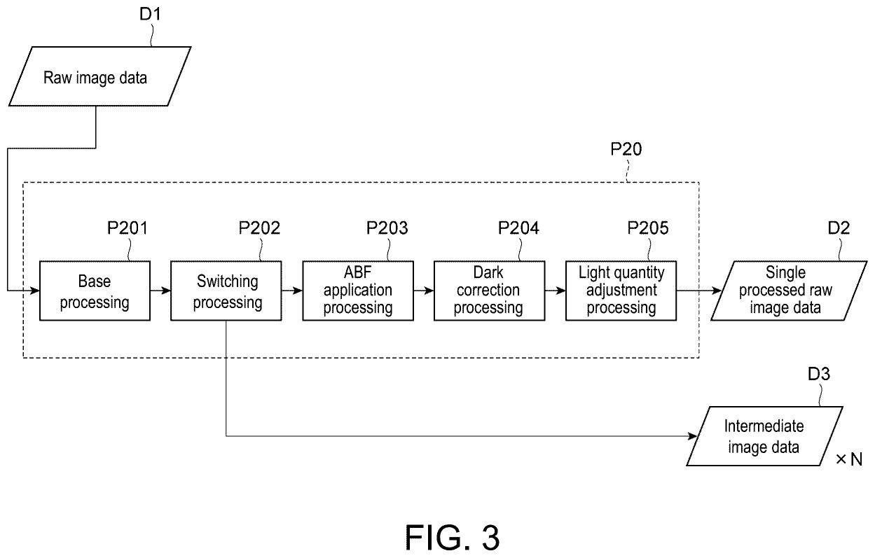

FIG. 3 is a block diagram describing processing for bypassing a part of preprocessing. As shown in FIG. 3, the preprocessing P20 constitutes the image processing group consisting of a series of image processings, and includes base processing P201, ABF application processing P203, dark correction processing P204, and light quantity adjustment processing P205. In the base processing P201, image processing such as fundamental correction and linearization is executed on the image data in Bayer format, which is raw image data D1 that is input. In the ABF application processing P203, an adaptive bilateral filter (ABF) is applied to the image data being a processing result of the base processing P201, and an edge strength is adjusted. In the dark correction processing P204, a black level acquired in advance is subtracted from the image data being a processing result of the ABF application processing P203, and noise is removed. In the light quantity adjustment processing P205, the image data being a processing result of the dark correction processing P204 is corrected so that the luminance of the peripheral region of the image is amplified. In the case where the light quantity adjustment processing P205 is completed, single processed raw image data D2 is generated as a processing result of the preprocessing P20. One piece of processed raw image data D2 is generated for one piece of raw image data D1.

Since the first extension processing P4 is noise reduction processing, in the example shown in FIG. 3, switching processing P202 is incorporated between the base processing P201 and the ABF application processing P203 on the basis of the definition data 122. In the switching processing P202, in the case where the predetermined switching condition is satisfied, the image processing pipeline P2 is switched by the processor 11 on the basis of the definition data 122. Accordingly, intermediate image data D3 is generated instead of the single processed raw image data D2. The intermediate image data D3 is a result of image processing immediately before the target image processing, and one piece of intermediate image data D3 is generated for one piece of raw image data D1. The intermediate image data D3 becomes a processing target of the first extension processing P4. The processor 11, for example, sequentially reads N pieces of raw image data D1 obtained by continuous shooting, executes the preprocessing P20 on each piece, and generates N pieces of corresponding intermediate image data D3. The processor 11 may store the intermediate image data D3 in the memory 12 every time the intermediate image data D3 is generated.

The processor 11 executes the first extension processing P4 on the basis of the first extension processing module 124. The first extension processing P4 is processing different from each image processing in the image processing pipeline P2. Accordingly, a new image processing option is given to the image processing pipeline P2. The processor 11 refers to the memory 12, and generates single synthesized raw image data on the basis of N pieces of intermediate image data.

The definition data 122 may contain an output destination of the single synthesized raw image data generated by the first extension processing P4. In the example shown in FIG. 2, the definition data 122 stores the white balance processing P21 as the output destination. The first extension processing module 124 operates the processor 11 so that the generated single synthesized raw image data is output to the output destination defined by the definition data 122. Accordingly, the processing result of the first extension processing P4 is taken over by the white balance processing P21, and the image processing pipeline P2 is executed. In this way, single synthesized image data in YUV format (synthesized YUV image data) is obtained from the single synthesized raw image data.

The processor 11 causes the synthesized image data processed by the image processing pipeline P2 to be output by the output part 15 or to be stored in the storage 13 (display/storage processing P3). Here, output switching processing P25 may be executed after execution of the image processing pipeline P2. In the output switching processing P25, the processor 11 determines the display/storage processing P3 or any of the image processing pipeline P2 to be an output destination of the image processing pipeline P2. The processor 11 determines the output destination on the basis of the definition data 122. The definition data 122 contains an output destination of image data generated by the image processing pipeline P2. In the example shown in FIG. 2, the definition data 122 stores the second extension processing P6 and the display/storage processing P3 as output destinations. For example, the processor 11 determines whether a predetermined output switching condition has been satisfied. The predetermined output switching condition is a condition for determining that the output destination of the image processing pipeline P2 is the second extension processing P6, and is determined in advance. The predetermined output switching condition may be, for example, reception of a user operation that enables the first extension processing P4 or the second extension processing P6, or satisfaction of a predetermined condition for time or environment. In the case where the predetermined output switching condition is satisfied, the processor 11 determines that the output destination of the image processing pipeline P2 is the second extension processing P6 in accordance with the definition data 122. If the predetermined output switching condition is not satisfied, the processor 11 determines that the output destination of the image processing pipeline P2 is the display/storage processing P3 in accordance with the definition data 122. The switching module 123 is a program that causes the processor 11 to function to execute the operations described above.

In the case where it is determined that the output destination of the image processing pipeline P2 is the second extension processing P6, the processor 11 executes the second extension processing P6 on the basis of the second extension processing module 126. The processor 11 executes image processing on the synthesized YUV image data output from the image processing pipeline P2. In this way, processing P7 including the image processing pipeline P2, the first extension processing P4, map generation processing P5, the output switching processing P25 and the second extension processing P6 is executed by the processor 11.

### Details of First Extension Processing

An operation of the processor 11 defined by the first extension processing module 124 is, for example, as follows.

### (1) Acquiring N Pieces of Intermediate Image Data D3

As described above, one piece of intermediate image data D3 is generated for one piece of raw image data D1. Hence, the processor 11 repeats the following processing N times (N is an integer of 3 or more). That is, the raw image data D1 output from the image sensor 10 is input to the image processing pipeline P2, the intermediate image data D3 is generated and is stored in the memory 12. Accordingly, N pieces of intermediate image data D3 are stored in the memory 12. The processor 11 refers to the memory 12 and acquires the N pieces of intermediate image data D3.

### (2) Preprocessing of Synthesis

The processor 11 selects reference image data from among a plurality of pieces of raw image data. The reference image data is raw image data serving as a reference for processing such as alignment or color correction. The reference image data is, for example, image data read first among a plurality of pieces of raw image data in the first extension processing P4. By first reading the image data stored first in the memory 12 among the plurality of pieces of raw image data, the processor 11 is able to set the earliest raw image data in chronological order as the reference image data. In the first extension processing P4, N−1 pieces of raw image data read after the reference image data serve as a plurality of pieces of comparison image data. Each of the plurality of pieces of comparison image data is synthesized with the reference image data.

The processor 11 detects corresponding pixels between the reference image data and each of the plurality of pieces of comparison image data. The corresponding pixels are pixels (pixels drawing the same subject) corresponding between the reference image data and one piece of comparison image data. The processor 11 calculates a global motion vector (GMV) representing a motion of the entire image between the reference image data and one piece of comparison image data. Next, the processor 11 aligns the reference image data with the one piece of comparison image data on the basis of the GMV. Then, the processor 11 calculates a difference in pixel value between the reference image data and the comparison image data at each pixel position. The processor 11 takes pixels having a difference in pixel value of 0 or less than or equal to a predetermined value as corresponding pixels, and stores them in the memory 12 as ghost map information associated with the pixel position. That is, the ghost map information is information in which information regarding the presence or absence of the corresponding pixels is associated with the pixel position. The processor 11 executes the above processing for each piece of comparison image data and generates the ghost map information for each piece of comparison image data.

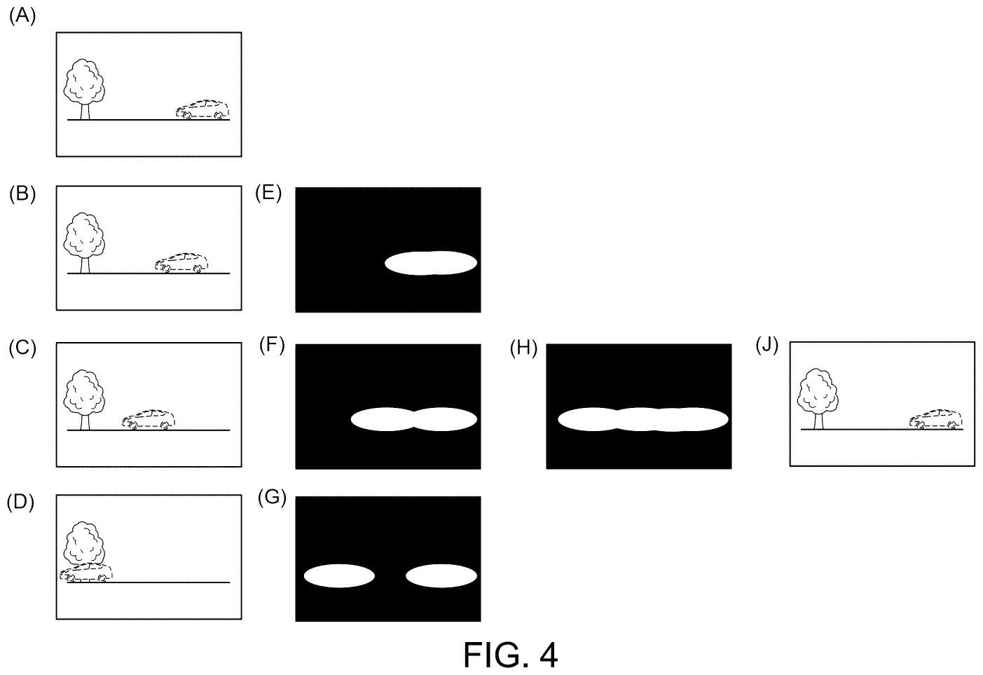

(A) to (J) of FIG. 4 are schematic diagrams describing the first extension processing. (A) to (D) of FIG. 4 are examples of raw image data captured in chronological order, and the subject is a traveling vehicle. (A) of FIG. 4 is an example of reference image data, and (B) to (D) of FIG. 4 are examples of comparison image data. (E) of FIG. 4 is an example of ghost map information corresponding to the comparison image data shown in (B) of FIG. 4. An area (pixel) shown in black in the figure is an area (pixel) determined to include a corresponding pixel to the reference image data. An area (pixel) shown in white in the figure is an area (pixel) determined to include no corresponding pixel to the reference image data. Similarly, (F) of FIG. 4 is an example of ghost map information corresponding to the comparison image data shown in (C) of FIG. 4, and (G) of FIG. 4 is an example of ghost map information corresponding to the comparison image data shown in (D) of FIG. 4. In this way, the ghost map information is generated for each piece of comparison image data.

### (3) Synthesis Processing

The processor 11 synthesizes the reference image data and each piece of comparison image data. The processor 11 synthesizes each pixel of the reference image data and each pixel of one piece of comparison image data. The processor 11 refers to the ghost map information generated with the comparison image data, and determines a weight at the time of synthesis for each pixel position. The processor 11 makes the weight at the time of synthesis smaller in the case where a pixel position of a synthesis target is associated with information indicating the absence of the corresponding pixel than in the case where the pixel position of the synthesis target is associated with information indicating the presence of the corresponding pixel. For example, if the pixel position of the synthesis target is associated with the information indicating the presence of the corresponding pixel, the processor 11 may set the synthesis weight to 1; if the pixel position of the synthesis target is associated with the information indicating the absence of the corresponding pixel, the processor 11 may set the synthesis weight to 0. Accordingly, a pixel value of the corresponding pixel is reflected in the synthesis of each pixel of the reference image data and each pixel of the one piece of comparison image data. For example, the pixel value of the pixel of the comparison image data shown in (B) of FIG. 4 is synthesized with the pixel value of each pixel of the reference image data shown in (A) of FIG. 4 with a weight corresponding to the ghost map information shown in (E) of FIG. 4. By executing the above-described processing on each piece of comparison image data, the processor 11 synthesizes the reference image data and each piece of comparison image data. Accordingly, the pixel values of the corresponding pixels of the reference image data and the pixel values of the corresponding pixels of the plurality of pieces of comparison image data are averaged, and synthesized raw image data with reduced noise is generated. (J) of FIG. 4 is an example of synthesized raw image data, and is a result obtained by synthesizing the pixel values of the pixels of the comparison image data shown in (B) of FIG. 4 to (D) of FIG. 4 with the pixel value of each pixel of the reference image data shown in (A) of FIG. 4 by the method described above.

The method for determining the synthesis weight is not limited to the method described above. In order to determine the synthesis weight, the processor 11 may estimate a noise amount at each pixel position from each pixel value of the reference image data. As described above, the noise amount is estimated from the ISO sensitivity at the time of shooting by using the calibration data at the time of factory shipment or the like. Accordingly, noise amount map information is generated in which a pixel position and an accurate noise amount are associated. The processor 11 may compare a difference between the pixel value of the reference image data and the pixel value of one piece of comparison image data with the noise amount at the pixel position, and adjust the synthesis weight. For example, if a difference between a square of the difference in pixel value and the noise amount is within a reference value, the processor 11 may not change the synthesis weight; if the difference between the square of the difference in pixel value and the noise amount is not within the reference value, the processor 11 may change the synthesis weight to 0. The processor 11 may estimate whether texture is present or absent in an image and change the synthesis method according to the presence or absence of texture.

### Map Generation Processing

On the basis of the map generation module 125, the processor 11 integrates the ghost map information for each piece of comparison image data., and generates accumulation map information (an example of map information) (map generation processing P5). The accumulation map information is information in which the pixel position of the synthesized raw image data is associated with information derived from at least one piece of raw image data of a plurality of pieces of raw image data. An example of the derived information is information regarding the presence or absence of the corresponding pixels. (H) of FIG. 4 is an example of the accumulation map information. (H) of FIG. 4 is obtained by integrating the ghost map information shown in (E) of FIG. 4 to (G) of FIG. 4. The generated accumulation map information is stored in the memory 12. The accumulation map information is used by the second extension processing P6 described later.

### Details of Second Extension Processing

The second extension processing P6 is image processing different from the first extension processing P4 and the image processing included in the image processing pipeline P2. An example of the second extension processing P6 is noise reduction processing different from the first extension processing P4. The second extension processing P6 takes the processing result of the image processing pipeline P2 as a processing target. That is, the second extension processing P6 is noise reduction processing (SFNR) in which single synthesized image data in YUV format is taken as the processing target. The processor 11 reduces noise in the synthesized image data using a smoothing filter such as a low frequency filter. Here, the processor 11 acquires from the memory 12 the accumulation map information generated in the map generation processing P5, and determines a pixel position to which the smoothing filter is applied.

On the basis of the accumulation map information, the processor 11 applies the smoothing filter to the pixel value of the pixel position of the synthesized image data associated with the information indicating the absence of the corresponding pixels. Accordingly, noise is removed from a pixel for which the synthesis weight is reduced in the first extension processing P4 (that is, a pixel for which the noise reduction processing has not been sufficiently performed in the first extension processing P4). In this way, when noise reduction processing is performed on YUV image data, since information on accurate corresponding pixel generated on the basis of a plurality of pieces of raw image data is used, the pixel position to which the smoothing filter is applied is accurately determined.

### Image Processing Method

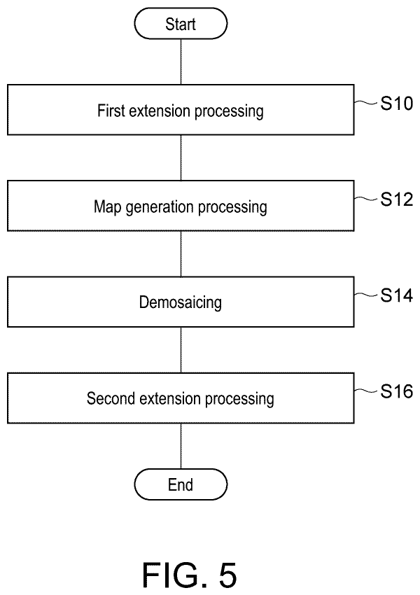

FIG. 5 is a flowchart of an image processing method. The flowchart shown in FIG. 5 is started at, for example, a timing when one piece of raw image data D1 is read from the memory 12. As shown in FIG. 5, the processor 11 executes MFNR as first extension processing (step S10: an example of a first processing step). In the first extension processing (step S10), synthesized raw image data with reduced noise is generated on the basis of a plurality of pieces of raw image data. Subsequently, as map generation processing (step S12: an example of a map generation step), the processor 11 generates accumulation map information. Subsequently, as demosaicing (step S14: an example of a demosaicing step), the processor 11 converts an image format of the synthesized raw image data generated by the first extension processing (step S10). The processor 11 converts the synthesized raw image data into RGB image data or YUV image data. As second extension processing (step S16: an example of a second processing step), the processor 11 executes SFNR on the RGB image data or YUV image data obtained in the demosaicing (step S14). At this time, the processor 11 refers to the accumulation map information generated by the map generation processing (step S12), and applies a smoothing filter to a pixel at a pixel position where MFNR has not been sufficiently performed. Thereby, the image processing method shown in FIG. 5 ends.

### SUMMARY OF EMBODIMENT

Since the image processing applied to RGB image data or YUV image data is image processing that intentionally modifies a pixel value, such as filter processing or correction processing, the information in accordance with natural law may not be maintained. Hence, in the case where MFNR is executed on a plurality of pieces of RGB image data or YUV image data as the target, correct estimation of the noise amount may not be possible, resulting in overestimation or underestimation of the ghost map information. For example, if the noise amount is greater than expected, although the pixels in that portion originally include corresponding pixels, it may be determined that there are no corresponding pixels, and the effect of noise reduction processing may be significantly reduced. In contrast, in the case where MFNR is executed on a plurality of pieces of raw image data as the target, a statistic of sensor data that can be described by natural law can be used. It is known that the noise amount follows the pixel value, and it is possible to estimate the ghost map information with high accuracy. Accordingly, it is possible for MFNR to exhibit higher performance on a plurality of pieces of raw image data as the target than on a plurality of pieces of RGB image data or YUV image data as the target.

In the case where SFNR is executed on raw image data as the target, even if the raw image data is in a state in which noise can be properly reduced, since many processings are performed thereafter, a phenomenon may occur in which the noise amount becomes non-uniform in an output result. As a result, quality of an output image may be degraded. In contrast, in the case where SFNR is executed on RGB image data or YUV image data as the target, since SFNR and output processing are close, such a phenomenon is less likely to occur. Accordingly, it is possible for SFNR to exhibit higher performance on RGB image data or YUV image data as the target than on raw image data as the target.

In the image processing device 1, MFNR is executed using a plurality of pieces of raw image data before execution of the demosaicing P22. In the raw image data before execution of the demosaicing P22, the information in accordance with natural law is maintained. In the image processing device 1, by predicting the noise amount using natural law, and adjusting the synthesis weight of the corresponding pixel on the basis of the estimated noise amount, the noise amount is properly reduced. A pixel at the pixel position where there is no corresponding pixel is passed to the next processing without reducing the noise amount. The accumulation map information is generated in which the ghost map information of each of the plurality of pieces of raw image data is integrated. Since the accumulation map information is generated on the basis of raw image data, that is, the pixel value that has not been artificially processed, compared with the case where an accumulation map is generated on the basis of the RGB image data or YUV image data, information of the corresponding pixel is more accurately represented.

In the image processing device 1, after execution of the demosaicing P22, the pixel position where there is no corresponding pixel is specified on the basis of the accumulation map information, and SFNR is executed in the specified pixel position. Accordingly, the noise amount of the pixel where the noise amount has not been reduced by MFNR is reduced. In this way, in the image processing device 1, by processing RGB image data or YUV image data using information created from raw image data, advantages of image processing performed on raw image data and advantages of image processing performed on full-color image data can be combined, and image quality can be improved.

### Modifications

Although the embodiment of the present disclosure has been described above, the present disclosure is not limited to the embodiment described above. For example, in the embodiment described above, a case is described as an example where the first extension processing P4 is noise reduction processing. However, the first extension processing P4 can be any processing. For example, the first extension processing P4 may be image synthesis (HDR synthesis: high-dynamic-range rendering) that does not aim at noise removal. It suffices if the map generation processing shown in FIG. 5 is carried out before execution of the second extension processing, and the map generation processing shown in FIG. 5 may be carried out after the demosaicing.

An operation of the image processing device 1 according to the embodiment described above may be realized by an image processing program that causes a computer to function. In the embodiment described above, the image processing device 1 may not have to include the image sensor 10, the storage 13, the input part 14 and the output part 15.

In the embodiment described above, an example is given in which the map information is accumulation map information. However, the map information is not limited to accumulation map information. The map information may be, for example, noise amount map information which is generated to determine the synthesis weight in the first extension processing P4 and in which a pixel position and a noise amount are associated with each other. Alternatively, the map information may be noise amount map information which is generated to determine the synthesis weight in image synthesis processing that does not aim at noise removal and in which the pixel position and the noise amount are associated with each other. The noise amount is not necessarily estimated by the method from the ISO sensitivity at the time of shooting by using the calibration data at the time of factory shipment or the like, and may be estimated on the basis of a statistic indicating a variation in pixel value between a pixel of interest selected from pixels of image data and a peripheral pixel located around the pixel of interest. Known examples of the statistic indicating such a variation in pixel value include variance.

If the map information is noise amount map information, in the second extension processing P6, SFNR may be executed in which the strength of the smoothing filter is increased at a pixel position where the noise amount is estimated to be greater than or equal to a first threshold, and the strength of the smoothing filter is reduced at a pixel position where the noise amount is estimated to be less than a second threshold. The second threshold is a value less than or equal to the first threshold. Accordingly, the processor 11 is able to execute image processing that applies a smoothing filter with a smoothing strength corresponding to the noise amount to a pixel value of the pixel position of the synthesized raw image data. Even in such a modification, in the image processing device 1, by processing RGB image data or YUV image data using information created from raw image data, advantages of image processing performed on raw image data and advantages of image processing performed on full-color image data can be combined, and image quality can be improved.

### DESCRIPTION OF REFERENCE NUMERALS

1: image processing device; 10: image sensor; 11: processor; 12: memory; 121: pipeline processing module; 123: switching module; 124: first extension processing module (example of first processing unit); 125: map generation module (example of map generation unit); 126: second extension processing module (example of second processing unit); D1: raw image data; D3: intermediate image data.

1. An image processing device comprising:
a first processing unit, detecting corresponding pixels between reference image data selected from among a plurality of pieces of raw image data and each of a plurality of pieces of comparison image data comprised in the plurality of pieces of raw image data, synthesizing the reference image data and the plurality of pieces of comparison image data on the basis of the corresponding pixels, and generating synthesized raw image data;
a map generation unit, generating map information in which a pixel position of the synthesized raw image data is associated with information derived from at least one piece of raw image data of the plurality of pieces of raw image data; and
a second processing unit, executing image processing different from that of the first processing unit on the synthesized raw image data that has been demosaiced, on the basis of the map information generated by the map generation unit.

2. The image processing device according to claim 1, wherein
the information derived from the at least one piece of raw image data is information regarding presence or absence of the corresponding pixels.

3. The image processing device according to claim 2, wherein
the first processing unit executes image processing that averages the corresponding pixels of the reference image data and the corresponding pixels of the plurality of pieces of comparison image data; and
the second processing unit executes image processing that applies a smoothing filter to a pixel value of the pixel position of the synthesized raw image data associated with information indicating the absence of the corresponding pixels.

4. The image processing device according to claim 1, wherein
the information derived from the at least one piece of raw image data is a noise amount estimated on the basis of a statistic indicating a variation in pixel value between a pixel of interest and a peripheral pixel located around the pixel of interest.

5. The image processing device according to claim 4, wherein
the second processing unit executes image processing that applies a smoothing filter with a smoothing strength corresponding to the noise amount to a pixel value of the pixel position of the synthesized raw image data.

6. A non-transitory computer-readable medium storing an image processing program causing a computer to function as:
a first processing unit, detecting corresponding pixels between reference image data selected from among a plurality of pieces of raw image data and each of a plurality of pieces of comparison image data comprised in the plurality of pieces of raw image data, synthesizing the reference image data and the plurality of pieces of comparison image data on the basis of the corresponding pixels, and generating synthesized raw image data;
a map generation unit, generating map information in which a pixel position of the synthesized raw image data is associated with information derived from at least one piece of raw image data of the plurality of pieces of raw image data; and
a second processing unit, executing image processing different from that of the first processing unit on the synthesized raw image data that has been demosaiced, on the basis of the map information generated by the map generation unit.

7. An image processing method comprising:
a first processing step of detecting corresponding pixels between reference image data selected from among a plurality of pieces of raw image data and each of a plurality of pieces of comparison image data comprised in the plurality of pieces of raw image data, synthesizing the reference image data and the plurality of pieces of comparison image data on the basis of the corresponding pixels, and generating synthesized raw image data;
a map generation step of generating map information in which a pixel position of the synthesized raw image data is associated with information derived from at least one piece of raw image data of the plurality of pieces of raw image data; and
a second processing step of executing image processing different from the image processing in the first processing step on the synthesized raw image data that has been demosaiced, on the basis of the map information generated by the map generation step.
